(19) United States
(12) Patent Application Publication
(10) Pub. No.: US 2018/0098034 A1
(43) Pub. Date: Apr. 5, 2018

(54) Method of Data Exchange between IP Video Camera and Server

(71) Applicant: OOO "ITV Group", Moscow (RU)

(72) Inventor: Murat K. ALTUEV, Chernogolovka (RU)

(21) Appl. No.: 15/720,095

(22) Filed: Sep. 29, 2017

(30) Foreign Application Priority Data
Sep. 30, 2016 (RU) 2016138710

(51) Int. Cl. H04N 7/18; H04L 29/06; G06F 17/30

(52) U.S. Cl. CPC H04N 7/181; H04N 7/01; G06F 17/3082; H04L 69/161

(57) ABSTRACT

A method for exchanging data between an IP video camera using an embedded video analytics and an external server comprises generating at least one video frame by said IP video camera; converting the video frame to a digital form by said IP video camera; processing the converted video frame via an IP processor; video cameras, using computer vision techniques, then creating metadata, transferring the received metadata to an external server for further use. The generated metadata is stored in the camera's IP storage, and then the stored metadata is read by the server. The metadata is stored in the DBMS of the IP video camera, the search query to the DBMS is received from the external server, the search query from the external server is processed in the DBMS, and the search results are transferred from the DBMS to the external server.

### RELATED APPLICATIONS

This application claims priority to Russian Patent Application No. RU 2016138710, filed Sep. 30, 2017, which is incorporated herein by reference in its entirety.

### FIELD OF THE INVENTION

The inventive variants refer to the field of data processing obtained by means of IP video cameras with built-in video analytics and transferring them to the server.

### BACKGROUND OF THE INVENTION

Video analytics is software-hardware or hardware that uses computer vision techniques for automated data collection, based on the analysis of video streaming (video analysis). Video analytics relies on algorithms for image processing and pattern recognition, which allow analyzing video without direct human participation. Video analytics is used as part of intelligent video surveillance systems, business management and video search.

Video analytics depending on specific purposes can realize many functions, such as: object detection, tracking the movement of objects, classification of objects, identification of objects, detection of situations, including alarm situations.

From the point of view of hardware and software architecture the following types of video analytics systems are distinguished: server video analytics and built-in video analytics. Server video analytics involves centralized processing of video data on the server. The server analyzes the video streams from a number of cameras or encoders on a central processor or on a graphics processor. The main disadvantage of server analytics is the need for server capacity for video processing. An additional disadvantage is the need for continuous transmission of video from the video data source on the server, which creates an additional load on the communication channels.

Built-in video analytics is implemented directly in the video data source, that is, in IP video cameras and encoders. Built-in video analytics works on a dedicated processor built into the IP video camera. The main advantage of the built-in video analytics is to reduce the load on the communication channels and the video data processing server. In the absence of objects or events, the video is not transmitted and does not download communication channels, and the processing server does not decode the compressed video for video analysis and indexing.

Known is a video surveillance system using communication systems, IP cameras, a server and a database is known. In this system, video stream processing is performed on the server (US 2014333777 A1, published on Nov. 13, 2014).

Also known are methods for identifying a video stream, including the use of a camera and a server. In these systems, video stream processing, including video frame identification, is performed on the server (US 2014099028 A1, published on Apr. 10, 2014).

Also known is a video analytics system of captured video content, containing IP video cameras and servers. The system provides data transfer via communication channels between IP cameras and servers. In this system, video stream processing is performed on the server (US 2014015964 A1, published Jan. 16, 2014). The system is selected as the prototype.

The disadvantage of the known solutions is the availability of an increased computing load on the server processors associated with the processing of video data.

### SUMMARY OF THE INVENTION

The tasks for solving the claimed inventive variants are to improve the processing speed of video data, using the IP camera of the video camera, reduce the load on the communication channels between the IP camera and the external server, and reduce the computing load of the external server.

The technical result of the claimed inventive variants is the reduction in the processing load of the server processor for processing video data, due to the fact that this processing is performed by the IP camera of the video camera which using built-in video analytics.

The technical result is achieved by using the following set of essential features:

A method to exchange data between an IP video camera which using build-in video analytics and at least one external server comprising:

forming at least one video frame by means of said IP video camera;

converting at least one video frame to a digital form by means of IP video camera;

processing at least one converted video frame by the processor of IP video camera, using computer vision techniques, followed by the generation of metadata;

transfer of received metadata to at least one external server for further use.

In a particular embodiment of the invention, a cloud server can act as said external server. Data exchange between said IP camera and said external server is performed over the TCP/IP protocol stack. Metadata can be structured formalized data of objects located on at least one converted video frame. Metadata can be information about moving objects, their size, type, color, identifiers, information about changes in the positions of objects in the scene of the video frame, speed and direction of movement of objects, biometric data of human faces, the recognized registration marks of vehicles, railway wagons, transport containers. The object identifier is retained from frame to frame. On at least one external server, real-time operations are performed including searching, identifying, evaluating, managing objects in at least one video frame over metadata generated for at least one video frame.

In another embodiment of the invention, a method for exchanging data between an IP video camera which using build-in video analytics and at least one external server comprising:

forming at least one video frame by means of IP video camera;

converting at least one video frame into a digital form by means of IP video camera;

processing at least one converted video frame by the processor of IP video camera, using computer vision techniques, followed by the generation of metadata;

preservation of the generated metadata in the storage of the IP video camera;

the server reads the stored metadata.

In a particular embodiment of the invention, a cloud server can act as external server. Data exchange between IP camera and external server is performed over the TCP/IP protocol stack. Metadata can be structured formalized data of objects located on at least one converted video frame. Metadata can be information about moving objects, their size, type, color, identifiers, information about changes in the positions of objects in the scene of the video frame, speed and direction of movement of objects, biometric data of human faces, the recognized registration marks of vehicles, railway wagons, and transport containers. The object identifier is retained from frame to frame. The IP video camera is configured to search, control the metadata of at least one video frame. The server reads the saved metadata permanently or at a predefined schedule.

In another embodiment of the invention, a method for exchanging data between an IP video camera which using build-in video analytics and at least one external server comprises the steps of:

forming at least one video frame by means of IP video camera;

converting at least one video frame into a digital form by means of IP video camera;

processing at least one converted video frame by the processor of IP video camera, using computer vision techniques, followed by the generation of metadata;

saving metadata of IP video camera in the DBMS;

receiving a search query from the external server to the DBMS;

processing in the DBMS a search request from external server;

transfer of search results from the DBMS to an external server.

In a particular embodiment of the invention, a cloud server can act as external server. Data exchange between IP video camera and external server is performed over the TCP/IP protocol stack. Metadata can be information about moving objects, their size, type, color, identifiers, and information about changes in the positions of objects in the scene of the video frame, speed and direction of movement of objects, as well as biometric data of human faces, recognized registration marks of vehicles, railcars, and transport containers. The object identifier is retained from frame to frame. DBMS is configured to store metadata which is presented in a geometric form, also, with the ability to search, evaluate, manage metadata of at least one video frame. A search query to the DBMS contains conditions that reveal changes in the geometric relationships of the metadata of objects in at least one video frame. The results of the search query are the time points during which the condition in the request is true. As a search query to the DBMS, a request can be made to search for all the time points when an object located on at least one video frame was on one side of the line and the next time it was on the other side of the line, and as a result. This request to the external server is transmitted information about the time points at which the object crossed the specified line. Also, as a search query to the DBMS can be acts a request for searching all objects located on at least one video frame that have moved from one area to another in a given direction. Also, as a search query to the DBMS can be act a query for searching all the time points in which the object moved in a given area.

### DETAILED DESCRIPTION OF THE PREFERRED EMBODIMENTS

Below is a description of examples of inventive variants of the claimed inventive variants. However, the present inventive variants are not limited to these embodiments only. It will be apparent to those skilled in the art that various other embodiments fall within the scope of the claimed inventive variants described in the claims.

Variants of methods for exchanging data between an IP video camera which using build-in video analytics and at least one external server are claimed.

Video data is obtained through an IP video camera. An IP camera should be understood as a digital video camera, the feature of which is the transmission of a video stream in digital format over an Ethernet network and TokenRing using the IP protocol. As a network device, each IP video camera on the network has its own IP address. Data exchange between the described devices, including IP video cameras, external servers is carried out on the stack of TCP/IP protocols.

IP video camera generates video frames, converts them into digital form, processes, receiving metadata.

Metadata are structured, formalized data of objects located on video frames converted by means of IP video camera. Metadata includes information about moving objects, their size, type, color, object identifiers, information about changes in the positions of objects in the scene of the video frame, speed and direction of movement of objects, biometric data of people present on video frames, recognized registration marks of vehicles, railway wagons, transport containers and many other parameters of objects located on video frames. Metadata are formed through methods of computer vision. For each video frame information is generated about the position in the frame of moving objects, their size, and color. For each object, a unique identifier is transmitted, which is retained from frame to frame. Also, the fact of changing the scene (i.e. the fact of the appearance of a new fixed object) or the fact of the transformation of a stationary object into a mobile object, as well as the positions of persons, the biometric vectors of persons, the positions of the numbers of cars, the results of recognition of car numbers are transmitted. Also, metadata can be considered information about the presence in the video frame of motion, smoke, and fire.

Most of the metadata has the character of geometric data. For each frame, zero or more “rectangles” are specified that describe the moving objects detected on the frame. To efficiently search for such data on conditions related to the geometric relationships of these “rectangles”, a special DBMS was created, which is located inside the IP video camera.

In the first embodiment of data exchange between an IP video camera and an external server, the received metadata is transferred to an external server for further use. Under the possible use by the server of the metadata generated by the IP video camera, there may be real-time operations involving the search, identification, evaluation, management of objects on the video frame by means of the metadata mentioned. In this case, the above operations can be performed by the database of server.

In the second embodiment of the data exchange between the IP video camera and the external server, the received metadata is stored in the storage of the IP video camera. The storage of the IP video camera is configured for searching objects, managing objects on video frames, and for creating metadata for them.

In the third embodiment of the data exchange between the IP video camera and the external server, the received metadata is stored in the specialized DBMS of the IP video camera. The IP video camera is configured to search objects, evaluate objects on video frames, and manage objects on the metadata generated for them.

All three methods use standard software, components, including computer systems, which include databases. The mentioned databases can be executed in the form of an external server, a data warehouse, a DBMS. And the data warehouse and specialized DBMS are built into the software of IP video cameras.

Any remote server can act as an external server, including a virtual server, which is a cloud-based data store.

The external server reads the stored metadata permanently, that is, when there is a connection between the IP video camera and the computer on which, for example, an external server is located. Or, the metadata is read out according to a predefined schedule. This schedule can be set and/or edited by the user in the system settings.

Next, we give examples of embodiments of the invention.

### Example 1—Search by Biometric Data of Human Faces

At the stage of recording data from the IP video camera to the external server or the storage or DBMS of the IP video camera, the system scans the faces of all people present in the frame. In this case, for each of the detected faces, the most frontal position is selected and a biometric vector (a brief description of the person) is constructed, which is stored in the form of metadata. When you later search the stored metadata, the system provides a certain reference image of the person. The reference image of a person is obtained by uploading a person's photo or highlighting his face on the video archive frame. For the reference image, a biometric vector will be constructed that will be compared with those already available in the database. As search results, all people whose faces are similar to the person on the reference image will be displayed on the operator's screen.

### Example 2—Search by Vehicle Numbers

The system has the ability to search for metadata, which is the registration marks of vehicles, for example, cars, as well as railway wagons and transport containers. When searching in the database for the numbers of vehicles, railway wagons, transport containers, an algorithm is used, similar to the recognition and search of persons. All vehicle numbers, as well as the identifiers of railway wagons, transport containers, appearing in the field of view of IP video cameras are stored in the database in text form. In the case where the image of the number and/or identifier is not clearly visible, the system constructs several hypotheses, including similar number symbols. Subsequently, the user can enter the required number as a search criterion and, as a result, the system will provide one or more corresponding number variants.

### Example 3—Search by Text Comments

This method allows you to find in a large amount of data points, once already marked by the operator. Comments can be left to either the entire frame, or to the selected area, as well as to the recording interval or to a certain alarm trigger.

### Example 4—Event Search

Also in the system there is a way to search the video archive of an event, knowing only the time of its occurrence. The user specifies a certain range of time within which an event is supposed to occur. This time interval is divided into as many uniform segments as fit on the operator's screen, for example, at 10. Images corresponding to each of these segments are displayed on the screen. The operator visually determines the segment on which the event occurred, selects it, and it is also divided into 10 segments. Each time these segments become more detailed, and in the end, in just a few steps, it becomes possible to determine the time of occurrence of an event to within a second, and, accordingly, see the details of this event.

### Example 5—Examples of Search Queries Sent to a Specialized DBMS from an External Server, and Query Results that are Transferred from the DBMS to an External Server

A specialized DBMS is one of the components of the IP video camera software. The DBMS is optimized for storing geometric data, and also for performing queries with geometric conditions. In this case, the obtained video frame metadata can be used to make any decisions in real time (immediately after receiving them), or stored in the DBMS for further operations with it, including search, evaluation, management. Search is carried out directly on the board of the IP camera, while the search results are transmitted to the server, and not the original metadata. This also reduces the computational load associated with data processing on the external server. And also, the plus is that the metadata is not lost with the temporary loss of communication between the IP video camera and the server.

Most of the metadata has the character of geometric data. Namely, for each frame, zero or more “rectangles” are indicated, describing the moving objects detected on the frame. Search terms are conditions formulated in a special query language. An example of such requests can be such a query (an example of the meaning, not of writing in the query language): a request to search for all the time points when the object in the video frame was on one side of the line, and the next time was on the other the sides of the line. As a result of processing this request, the external server transmits information about the times at which the object crossed the specified line. For example, an IP video camera is installed on the street near the roadway and forms video footage that detects the pedestrian crossing of this roadway. To identify and/or search for a person in the desired time interval, this system allows you to determine whether a person crossed the road or not. Also an example of a search query to the DBMS, can be a request to search for all objects that are on the video frame, which moved from one area to another in a given direction. For example, an IP video camera is installed in the bank branch where the robbery took place. To investigate this robbery, the operator looks through the video archive received from the IP video camera within a certain time period. The following search queries can be specified: the search for a certain number of people fixed in the premises of the bank at 14:00, which moved from one room to another from left to right. As a response to such a request, the DBMS will provide to the external server time intervals in which the number of people interested in moving in the given direction. And also, it is possible to clarify the time intervals for the origin of an event, if they are unknown. As a response to such a request, such time intervals can be given.

Embodiments of the present inventive variants can be implemented using software, hardware, software logic, or a combination thereof. In an exemplary embodiment, the program logic, software, or instruction set is stored on one of various conventional computer-readable media. In the context of this document, a “computer-readable media” can be any environment or facilities that can contain, store, transmit, distribute, or transport instructions for use by the instruction execution system, equipment, or device, such as a computer. The computer-readable media may include a non-volatile computer-readable storage medium, which may be any medium or medium containing or storing instructions for use by the instruction execution system, equipment or device, such as a computer, or for use in connection with them.

In one embodiment, a circuit or user interface circuit configured to provide at least some of the control functions described above may be proposed.

If necessary, at least some of the various functions discussed herein may be performed in a manner different from the presented order and/or simultaneously with each other. In addition, if necessary, one or more of the functions described above may be optional or may be combined.

While various aspects of the present inventive group are characterized in the independent claims, other aspects of the inventions include other combinations of features from the described embodiments and/or dependent claims, together with the features of the independent claims, wherein the said combinations are not necessarily explicitly indicated in the claims.

In the opinion of the authors, the declared set of essential features is sufficient to achieve the stated technical result and is in a causal relationship with it.

Preliminary conducted patent studies and information searches are sufficiently objectively indicative that the claimed inventive variants meet all the criteria for patentability of the invention.

What is claimed is:

1. A method of exchanging data between an IP video camera with built-in video analytics capability and at least one server, the method comprising:
forming at least one video frame by the IP video camera;
converting the at least one video into a digital form by the IP video camera to obtain at least one converted video frame;
processing the at least one converted video frame by a processor of the IP video camera by using computer vision to form metadata; and
transferring the metadata to at least one external server.

2. The method of claim 1, wherein the at least one external server is a cloud server.

3. The method of claim 1, wherein communication between the IP video camera and the at least one external server is carried out according to a stack of TCP/IP protocols.

4. The method of claim 1, wherein the metadata are structured to represent formal data objects in the at least one transformed video frame.

5. The method of claim 1, wherein the metadata are comprising information about moving objects, the information about the moving objects being their size, type, color, identifiers, information about changes in positions of the moving objects in a scene of the at least one video frame, speed and direction of movement of the moving objects, biometric data of human faces, detected registration plates of vehicles, detected registration plates of railway wagons, and/or detected registration plates of transport containers.

6. The method of claim 5, wherein at least one identifier of the identifiers is retained from one frame to another frame.

7. The method of claim 1, further comprising performing real-time operations on the at least one external server, the real-time operations being searching, identifying, evaluating, managing objects in the at least one video frame in accordance with the metadata generated for the at least one video frame.

8. A method of exchange data between an IP video camera with built-in video analytics capabilities and at least one external server, the method comprising:
forming at least one video frame by the IP video camera;
converting the at least one video into a digital form by the IP video camera to obtain at least one converted video frame;
processing the at least one converted video frame by a processor of the IP video camera by using computer vision to form metadata;
storing the metadata in a storage of the IP video camera to provide stored metadata; and
reading the stored metadata by the at least one external server.

9. The method of claim 8, wherein the at least one external server is a cloud server.

10. The method of claim 8, wherein communication between the IP video camera and the at least one external server is carried out according to a stack of TCP/IP protocols.

11. The method of claim 8, wherein the metadata are structured to represent formal data objects in the at least one transformed video frame.

12. The method of claim 8, wherein the metadata are comprising information about moving objects, the information about the moving objects being their size, type, color, identifiers, information about changes in positions of the moving objects in a scene of the at least one video frame, speed and direction of movement of the moving objects, biometric data of human faces, detected registration plates of vehicles, detected registration plates of railway wagons, and/or detected registration plates of transport containers.

13. The method of claim 12, wherein at least one identifier of the identifiers is retained from one frame to another frame.

14. The method of claim 8, wherein the storage of the IP video camera is configured to search and control the metadata of the at least one video frame.

15. The method of claim 8, wherein reading of the stored metadata from the at least one external server occurs continuously or in accordance with a predefined schedule.

16. A method of exchange data between an IP video camera with built-in video analytics capabilities and at least one external server, the method comprising:
forming at least one video frame by the IP video camera;
converting the at least one video into a digital form by the IP video camera to obtain at least one converted video frame;
processing the at least one converted video frame by a processor of the IP video camera by using computer vision to form metadata;
storing the metadata of the IP video camera in a DBMS;
receiving a search query from the at least one external server to the DBMS;
processing the search query in the DBMS to obtain search results; and
forwarding the search results from the DBMS to the at least one external server.

17. The method of claim 16, wherein the at least one external server is a cloud server.

18. The method of claim 16, wherein communication between the IP video camera and the at least one external server is carried out according to a stack of TCP/IP protocols.

19. The method of claim 16, wherein the metadata are comprising information about moving objects, the information about the moving objects being their size, type, color, identifiers, information about changes in positions of the moving objects in a scene of the at least one video frame, speed and direction of movement of the moving objects, biometric data of human faces, detected registration plates of vehicles, detected registration plates of railway wagons, and/or detected registration plates of transport containers.

20. The method of claim 19, wherein at least one identifier of the identifiers is retained from one frame to another frame.

21. The method of claim 16, wherein the DBMS is configured to store the metadata presented in a geometric form, search, evaluate, and control the metadata of the at least one video frame.

22. The method of claim 16, wherein the search query to the DBMS comprises conditions disclosing changes in geometric relationships of the metadata of an object in the at least one video frame.

23. The method of claim 16, wherein the search results are presented as time intervals during which a condition in the search query is true.

24. The method of claim 16, wherein the search query is a query for determining those times when an object in the at least one video frame crossed a predetermined line by sending the search query to search for all points in time during which an object was present on one side of the predetermined line in the at least one video frame and for the next time during which the object was present on the other side of the line, and transmitting information about those time to the at least one external server.

25. The method of claim 16, wherein the search query is a query for searching for all objects in the at least one video frame which moved in a predetermined direction from one region to another.

26. The method of claim 16, wherein the search query is a query for searching for all times when an object moved in a predetermined region.
